(19) United States
(12) Patent Application Publication
(10) Pub. No.: US 2015/0178706 A1
(43) Pub. Date: Jun. 25, 2015

(54) APPARATUS AND METHOD FOR PROXY GOODS AND SERVICES PRESENTATION TO A CONSUMER MOBILE DEVICE

(71) Applicant: North Star Nest, LLC, Los Olivos, CA (US)

(72) Inventors: Elisabeth Galvin, Reno, NV (US); Gary Allen, Solvang, CA (US)

(21) Appl. No.: 14/559,675

(22) Filed: Dec. 3, 2014

Related U.S. Application Data
(60) Provisional application No. 61/911,370, filed on Dec. 3, 2013.

(51) Int. Cl. G06Q 20/20; H04L 29/08; H04L 29/06

(52) U.S. Cl. CPC G06Q 20/202; H04L 67/42; H04L 67/28

(57) ABSTRACT

A system for proxy goods and services presentation incorporates a backbone server having internet and secure link connectivity. A client environment proxy server is connected for internet communication with the backbone server and has network connectivity. Client back end servers and client websites are connected to the backbone server and a merchant gateway is connected to the backbone server through a secure link. A point of sale device is connected to the client environment proxy server through a network and a consumer mobile device is connected to the client environment proxy server through the network.

### REFERENCES TO RELATED APPLICATIONS

This application claims priority of US Provisional Application Ser. No. 61/911,370 filed on Dec. 3, 2013 having the same title as the present application and a common assignee, the disclosure of which is incorporated herein by reference.

### BACKGROUND OF THE INVENTION

1. Field

The present invention is in the technical field of consumer purchase transactions. More particularly, the present invention provides a data processing and information system employing both backbone and proxy servers for interaction with a point of sale device and a consumer mobile device for real-time identification of a menu of available goods and services, purchases from the presented menu and fulfillment of the purchase ordered.

2. Related Art

Consumers are highly mobile and with the presence of personal devices that provide internet, phone or wireless connectivity for almost instantaneous communication the ability to present menus of goods and services to the consumer are expanding. Airlines and travel/transportation companies are rapidly expanding into “buy on board” (BOB) systems for not only meals, snacks or other onboard services but integration of generalized consumer catalogue type purchase systems. Other providers such as sports venues, hotels, resorts and even community organizations such as chambers of commerce desire to offer similar purchasing capabilities to patrons frequenting their venue/location.

Current consumer transaction systems are typically fragmented into point of sale systems or information presentation systems that are not coordinated. Consequently, consumers often are confused or disenchanted and do not purchase at all or do not purchase the optimum product/service; either from a location or client information provider perspective.

It is therefore desirable to provide an integrated system operable in association with a particular client for identification of available or selected goods and services to a consumer with a menu on the consumer's own device or a point of sale device with integrated capability for purchase of menu items and direct fulfillment of the order.

### SUMMARY OF THE INVENTION

The present invention is a system for proxy goods and services presentation which incorporates a backbone server having internet and secure link connectivity. A client environment proxy server is connected for internet communication with the backbone server and has network connectivity. Client back end servers and client websites are connected to the backbone server and a merchant gateway is connected to the backbone server through a secure link. A point of sale device is connected to the client environment proxy server through a network and a consumer mobile device is connected to the client environment proxy server through the network.

### BRIEF DESCRIPTION OF THE DRAWINGS

These and other features and advantages of the present invention will be better understood by reference to the following detailed description of exemplary embodiments when considered in connection with the accompanying drawings wherein:

FIG. 1 is a block diagram of the system elements and their interaction.

### DETAILED DESCRIPTION OF THE INVENTION

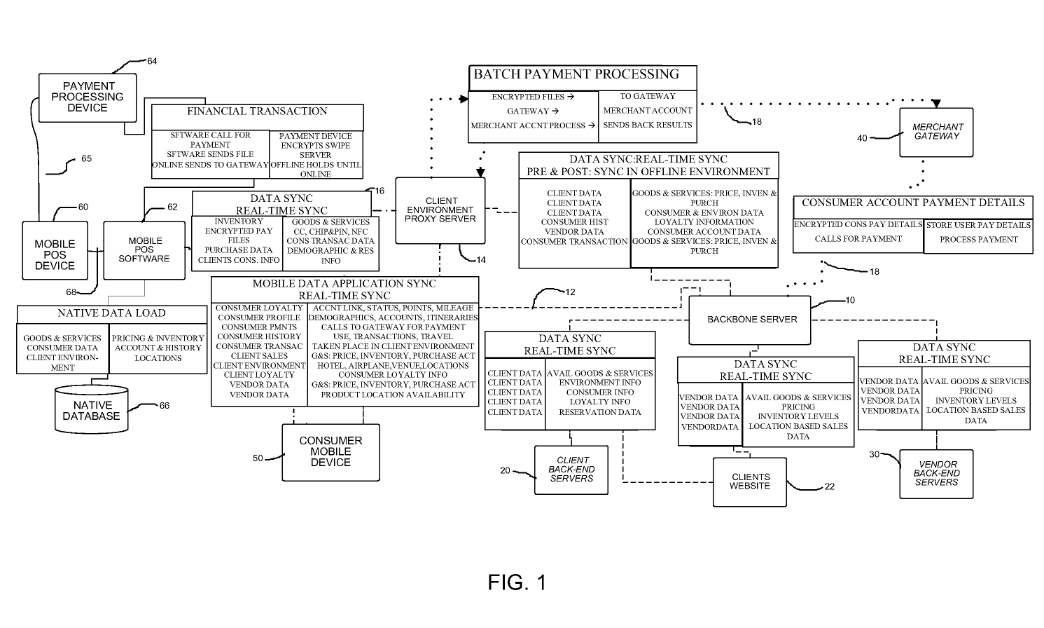

Describing an embodiment of the invention in more detail with reference to the drawings, FIG. 1 shows a backbone server 10. The backbone server 10 operates as the back office system that collects and exchanges data with all elements in the system. As shown, backbone server 10 uses an internet connection 12 to exchange data with five elements over internet connections; a client environment proxy server 14, client back end servers 20, client websites 22, vendor back end servers 30, and at least one consumer mobile device 50. Backbone server 10 uses a secure connection 18 to send encrypted payment files to a merchant gateway 40. For the descriptions herein “the client” may be an operating organization such as an airline or transportation company, a venue operator such as a sports complex or mall, or a hotel, resort or other residential facility.

The client environment proxy server 14 is a server that is installed at the client's environment, for example on an aircraft, in a sports stadium or in a hotel/resort, and provides operational data exchange with a point of sale device 60, to be described in greater detail subsequently, and the consumer mobile device 50. Data provided by the client environment proxy server to the point of sale device 60 and the consumer mobile device 50 for display and interaction may include such information as goods and services data such as goods and services available and goods and services available at location for both the client through the point of sale device 60 and the consumer through the consumer mobile device 60. The information may also include pricing of all goods and services, purchase activity outside of client environment and purchase activity within client environment to allow real time assessment by the consumer and transactions between the client and consumer through the point of sale device 60 or mobile device 50, respectively. In the exemplary embodiment of FIG. 1, the client environment proxy server 14 collects and exchanges data with two WiFi connected elements through a network 16, one internet connected element using an internet connection and one secure element using a secure connection to send payment files to the merchant gateway 40.

Client backend servers 20 are the client's servers that house the business systems. Client website 22 is the client's website where consumers will have access to goods and services through the backbone server 10.

Vendor backend servers 30 are vendors' servers that house the information that will be exchanged to and from backbone server 10 regarding goods or services of the connected vendors. Connected vendors may be selected by the client specifically or may be geographically or electronically connected to or available to a consumer based on the consumer interaction with the client, such as a traveler on an airline client or a patron at a sports venue client.

Merchant gateway 40 is a gateway associated with the vendor that will house and process consumer Payments and Account information.

Consumer mobile device 50 is a consumer's mobile device that can be any device running iOS, Android and Windows operation systems. In the FIG. 1, consumer mobile device 50 has two data flow paths, WiFi and internet, which are explained below.

Mobile POS device 60 is a mobile point of sale (POS) device for use within the client's environment that can be Apple, Samsung, HP, Lenovo, Motorola or any other OEM POS device that uses iOS, Android or Windows operating systems. Mobile POS device 60 helps create and assist consumer transactions by enabling the client to see and create transactional activity, specifically regarding products and services available at that client's environment. Mobile POS software 62 is a software application (iOS, Android or Windows) providing functional routines operating on the mobile POS device 60 that allows the client to see and create consumer transactions. The mobile POS software 62 also updates client environment proxy server 14 with all transactional data. Mobile POS software 62 employs three data flow paths, explained below. Payment processing device 64 is a hardware device that collects payment from the consumer using their credit card. The payment processing device 64 may be connected to the mobile POS device 60 through an audio jack or USB outlet. Payment processing device 64 can also be a standalone device connecting to mobile POS device 60 using Bluetooth® or a wireless network. Native database 66 is a local database that stores data on mobile POS device 60. This data is a combination of activity from the client who processes a transaction and data that is sent from client environment proxy server 14 through the mobile POS software 62 to be stored in native database 66

The mobile POS device 60 is connected either physically or wirelessly to payment processing device 64 to securely process payments via Credit Card, Chip and Pin or NFC technologies. This is represented in the diagram as connection 65 between the two devices.

The mobile POS device 60 runs the mobile POS software 62 on its operation system which can be iOS, Android or Windows. This is represented in the diagram as connection 68 between the two devices.

The mobile POS device 60 stores the mobile POS software 62 data in native database 66 as explained previously. This is represented in the diagram as connection 70 between the two devices.

In FIG. 1 the connections between operating elements are represented as follows. Internet connection 12 is represented by dashed lines. These represent communications pathways that will always have an Internet connection and data will sync in real-time as activity is being recorded. Network connections 16 are represented by long and short dashed lines. These represent communication pathways where an Internet connection may be inconsistent and a wireless network is employed to allow communication between devices. Note there will be instances where the wireless network has an internet connection but during the times internet service is not available the wireless network will be able to exchange the data between the transaction operating elements. Secure connections 18 are represented by dotted lines. These communications pathways represent a secure connection that processes consumer payments information and account details. Solid line connections are physical relationships between hardware that is assembled or integrated as the Mobile POS device, i.e. Credit Card Swiper (payment processing device) and an iPhone, or Android Phone/Tablet with memory and communications capability.

The architecture of the system provides for unique data exchange between the system elements for communication of available goods and services to a consumer and completion of purchase and fulfillment requirements for a transaction elected by the consumer. In data exchange between the backbone server 10 and the vendor back end servers 30 data is pushed to and from backbone server 10 and vendor back end servers 30 regarding the data sets shown in Table 1.

TABLE 1
From vendor backend servers 30 To backbone server 10: Available goods
and services
From vendor backend servers 30 To backbone server 10: Pricing
Information
From vendor backend servers 30 To backbone server 10: Inventory Levels
From vendor backend servers 30 To backbone server 10: Location based
sales availability data
From backbone server 10 To vendor backend servers 30: Sales Data
From backbone server 10 To vendor backend servers 30: Current
Inventory Levels

Data is synced in real-time as the elements in Table 1 are changed by the vendors.

In data exchange between the backbone server 10 and the client website 22, data is pushed to and from backbone server 10 and client website 22 regarding the data sets shown in Table 2

TABLE 2
From client website 22 To backbone server 10: Available goods and
services
From client website 22 To backbone server 10: Pricing Information
From client website 22 To backbone server 10: Inventory Levels
From client website 22 To backbone server 10: Location based sales
availability data
From backbone server 10 To client website 22: Sales Data
From backbone server 10 To client website 22: Current Inventory
Levels

Data is synced in real-time as the elements in Table 2 are changed in either the backbone server 10 or the client website 22.

In Data Exchange between the backbone server 10 and the client back end servers 20 data is pushed to and from backbone server 10 and client back end servers 20 regarding the data sets shown in Table 3.

TABLE 3
From client back end servers 20 To backbone server 10: Available goods
and services
From client back end servers 20 To backbone server 10: Client
Environment Data
From client back end servers 20 To backbone server 10: Consumer Info
From client back end servers 20 To backbone server 10: Loyalty Info
From client back end servers 20 To backbone server 10: Reservation Data
From backbone server 10 To client back end servers 20: Inventory Levels
From backbone server 10 To client back end servers 20: Consumer Sales
Data
From backbone server 10 To client back end servers 20: Loyalty updates
From backbone server 10 To client back end servers 20: Consumer History

Data is synced in real-time as the elements in Table 1 are changed in either the backbone server 10 or client back end server 20.

In Data Exchange between the backbone server 10 and the client environment proxy server 14 data is pushed to and from backbone server 10 and client environment proxy server 14 regarding data sets shown in Table 4.

TABLE 4
From backbone server 10 To client environment proxy server 14:
Consumer Loyalty

Account Linking
Reward Level
Point Balance
Mileage Balance

From backbone server 10 To client environment proxy server 14:
Consumer Profile Data

Basic Demographics
Linked Accounts (Social, Reward)
Itineraries

From backbone server 10 To client environment proxy server 14:
Consumer Payments

History of Purchases
All payment detail on file will be held at our Gateway (40)

From backbone server 10 To client environment proxy server 14:
Consumer History

Application Activity
Transaction History
Itinerary Data, Current & History

From backbone server 10 To client environment proxy server 14:
Consumer Transactional Data

Purchases taken place at clients environment.

From backbone server 10 To client environment proxy server 14:
Clients Sales Data

Goods and Services available
Goods and services available at location
Pricing of goods and services
Inventory levels of Goods and Services
Purchase Activity outside of client environment
Purchase Activity inside the client environment.

From backbone server 10 To client environment proxy server 14:
Client Environment Data

Airline: Goods and services available
Inventory Levels
Pricing
Hotel: Goods and services available
Inventory Levels
Pricing
Venue: Goods and services available
Inventory Levels
Pricing

From backbone server 10 To client environment proxy server 14: Vendor
Data

Goods and Services
Pricing
Purchases
Product Location Availability

From client environment proxy server 14 To backbone server 10:
Activity

Account Changes
Purchases

Data is synced in real-time as the elements in Table 1 are changed in either the backbone server 10 or client environment proxy server 14.

In Data Exchange between the Backbone Server 10 and the consumer mobile device 50 data is pushed to and from backbone server 10 and consumer mobile device 50 regarding data sets shown in Table 5.

TABLE 5
From backbone server 10 To consumer mobile device 50: Consumer
Loyalty

Account Linking
Reward Level
Point Balance
Mileage Balance

From backbone server 10 To consumer mobile device 50: Consumer
Profile Data

Basic Demographics
Linked Accounts (Social, Reward)
Itineraries
History of Purchases
All payment detail on file will be held at our Gateway (40)

From backbone server 10 To consumer mobile device 50: Consumer
History

Application Activity
Transaction History

From backbone server 10 To consumer mobile device 50: Goods and
Services Data

Client: Goods and Services available
Client: Goods and services available at location
Vendor: Goods and Services available
Vendor: Goods and services available at location
Pricing of all goods and services
Purchase Activity outside of the client environment
Purchase Activity within the client environment.

From consumer mobile device 50 To backbone server 10: All Account
Activity

Changes
Purchases
Use

Data is synced in real-time as the elements in Table 5 are changed.

In Data Exchange between the backbone server 10 and the merchant gateway 40 data is pushed to and from backbone server 10 and merchant gateway 40 regarding data sets as shown in Table 6.

### Table 6

From backbone server 10 to merchant gateway 40: Payment Account Information
From backbone server 10 to merchant gateway 40: Pricing Information
From merchant gateway 40 to backbone server 10: Approval Receipt
From merchant gateway 40 to backbone server 10: Denial Receipt
Data is synced in real-time as the elements in Table 6 are changed.

In Data Exchange between the client environment proxy server 14 and the backbone server 10 data is pushed to and from client environment proxy server 14 and backbone server 10 regarding the data sets shown in Table 7.

TABLE 7
From backbone server 10 To client environment proxy server 14:
Consumer Loyalty (based on consumers in Itinerary)

Account Linking
Reward Level
Point Balance
Mileage Balance

From backbone server 10 To client environment proxy server 14:
Consumer Profile Data (based on consumers in Itinerary)

Basic Demographics
Linked Accounts (Social, Reward)
Itineraries
History of Purchases
All payment detail on file will be held at merchant gateway 40

From backbone server 10 To client environment proxy server 14:
Consumer History (based on consumers in Itinerary)

Application Activity
Transaction History

From backbone server 10 To client environment proxy server 14: Goods
and Services Data

Client: Goods and Services available
Client: Goods and services available at location
Client Itinerary information
Vendor: Goods and Services available
Vendor: Goods and services available at location
Pricing of all goods and services
Purchase Activity outside of the client environment
Purchase Activity within the client environment.

From client environment proxy server 14 to backbone server 10:
Transactions & Activity Data

Consumer Purchases
Consumer Account Changes
Consumer Loyalty Debits and Credits
Client Inventory Levels
Vendor Inventory Levels
Client Sales Activity
Vendor Sales Activity

Data is synced in real-time as the elements in Table 7 are changed unless internet connectivity is not available. In the scenario that there is no internet connectivity, data will be exchanged once connectivity becomes available.

In data exchange between the client environment proxy server 14 and the consumer mobile device 50 data is pushed to and from client environment proxy server 14 and consumer mobile device 50 regarding the data sets shown in Table 8.

TABLE 8
From client environment proxy server 14 To consumer mobile device 50:
Consumer Loyalty

Account Linking
Reward Level
Point Balance
Mileage Balance

From client environment proxy server 14 To consumer mobile device 50:
Consumer Profile Data

Basic Demographics
Linked Accounts (Social, Reward)
Itineraries
History of Purchases
All payment detail on file will be held at merchant gateway 40

From client environment proxy server 14 To consumer mobile device 50:
Consumer History

Application Activity
Transaction History

From client environment proxy server 14 To consumer mobile device 50:
Goods and Services Data

Client: Goods and Services available
Client: Goods and services available at location
Vendor: Goods and Services available
Vendor: Goods and services available at location
Pricing of all goods and services
Purchase Activity

From consumer mobile device 50 to client environment proxy server 14:
Consumer Account

Transactions & Activity Data
Consumer Purchases
Consumer Account Changes
Consumer Account Activity
Consumer Loyalty Debits and Credits

Data is synced in real-time as the elements in Table 8 are changed.

In Batch Payment Processing data exchange by the client environment proxy server 14 data is pushed to and from client environment proxy server 14 regarding the data sets shown in Table 9.

TABLE 9
From backbone server 10 to merchant gateway 40: Payment Information
(from payment processing device 64)
From backbone server 10 to merchant gateway 40: Transaction Amount
and Details Information
To client environment proxy server 14: Approval Receipt
To client environment proxy server 14: Denial Receipt

Data is synced in real-time as the elements in table 9 are changed.

The mobile POS software 62 operates in three data flow paths for information exchange with the client environment proxy server 14 and the other elements of the mobile POS device 60, payment processing device 64 and Native database 66 as shown in Table 10.

TABLE 10
Network Data flow path between mobile POS software 62 and client
environment proxy server 14.

From client environment proxy server 14 to mobile POS software 62:
Goods and Services available in clients environment
From client environment proxy server 14 to mobile POS software 62:
Payment receipt
From client environment proxy server 14 to mobile POS software 62:
Client Itinerary (consumer data)

Basic Demographics
Location in clients environment
Loyalty Information

From mobile POS software 62 to client environment proxy server 14:
Consumer Sales Data
From mobile POS software 62 to client environment proxy server 14:
Inventory Data

Secure Data flow path between mobile POS software 62 and payment
processing device 64.

From mobile POS software 62 to payment processing device 64:
Calls to enable for payment transaction
From payment processing device 64 to mobile POS software 62:
Takes payment transaction and sends encrypted file.

Data Loaded into payment processing device 64 connected to mobile
POS software 62 from client environment proxy server 14

From client environment proxy server 14 stored in payment
processing device 64: Goods and Services available in clients
environment
From client environment proxy server 14 stored in payment
processing device 64: Payment receipt
From client environment proxy server 14 stored in payment
processing device 64: Clients Itinerary (consumer data)

Basic Demographics
Location in clients environment
Loyalty Information

From mobile POS software 62 to client environment proxy server 14:
Consumer Sales Data

Data is synced in real-time as the elements in Table 10 are changed.

In Data Exchange between the client back end servers 20 and backbone server 10 data is pushed to and from client back end servers 20 and backbone server 10 regarding the data sets in Table 11.

TABLE 11
From client back end servers 20 To backbone server 10: Available
goods and services
From client back end servers 20 To backbone server 10: Client
Environment Data
From client back end servers 20 To backbone server 10: Consumer Info
From client back end servers 20 To backbone server 10: Loyalty Info
From client back end servers 20 To backbone server 10: Reservation Data
From backbone server 10 To client back end servers 20: Inventory Levels
From backbone server 10 To client back end servers 20: Consumer Sales
Data
From backbone server 10 To client back end servers 20: Loyalty updates
From backbone server 10 To client back end servers 20: Consumer History

Data is synced in real-time as the elements in Table 11 are changed.

In Data Exchange between the client website 22 and backbone server 10 data is pushed to and from client website 22 and backbone server 10 regarding the data sets shown in Table 12

TABLE 12
From client website 22 To backbone server 10: Available goods and
services
From client website 22 To backbone server 10: Pricing Information
From client website 22 To backbone server 10: Inventory Levels
From client website 22 To backbone server 10: Location based sales
availability data
From backbone server 10 To client website 22: Sales Data
From backbone server 10 To client website 22: Current Inventory
Levels

Data is synced in real-time as the elements in Table 12 are changed.

In data exchange between the vendor back end servers 30 and the backbone server 10 data is pushed to and from vendor backend servers 30 and backbone server 10 regarding the data sets shown in Table 13.

TABLE 13
From vendor backend servers 30 To backbone server 10: Available goods
and services
From vendor backend servers 30 To backbone server 10: Pricing
Information
From vendor backend servers 30 To backbone server 10: Inventory
Levels
From vendor backend servers 30 To backbone server 10: Location based
sales availability data
From backbone server 10 To vendor backend servers 30: Sales Data
From backbone server 10 To vendor backend servers 30: Current
Inventory Levels

Data is synced in real-time as the elements in Table 13 are changed.

As previously described, the merchant gateway 40 provides a secure transaction processing capability that will house and process consumer Payments and Account information. In data exchange with between the backbone server 10 and the merchant gateway 40 data is pushed to and from backbone server 10 and merchant gateway 40 regarding the data sets described in Table 14.

TABLE 14
From backbone server 10 to merchant gateway 40: Payment Account
Information
From backbone server 10 to merchant gateway 40: Pricing Information
From merchant gateway 40 to backbone server 10: Approval Receipt
From merchant gateway 40 to backbone server 10: Denial Receipt

Data is synced in real-time as the elements in Table 14 are changed.

In addition to communication with the client environment proxy server 14 the consumer mobile device 50 may communicate directly with the backbone server 10 when internet connectivity is available. In Data Exchange between the mobile device 50 and the backbone server 10 data is pushed to and from backbone server 10 and consumer mobile device 50 regarding the data sets shown in Table 15.

TABLE 15
From backbone server 10 To consumer mobile device 50: Consumer
Loyalty

Account Linking
Reward Level
Point Balance
Mileage Balance

From backbone server 10 To consumer mobile device 50: Consumer
Profile Data

Basic Demographics
Linked Accounts (Social, Reward)
Itineraries
History of Purchases
All payment detail on file will be held at merchant gateway 40

From backbone server 10 To consumer mobile device 50: Consumer
History

Application Activity
Transaction History

From backbone server 10 To consumer mobile device 50: Goods and
Services Data

Client: Goods and Services available
Client: Goods and services available at location
Vendor: Goods and Services available
Vendor: Goods and services available at location
Pricing of all goods and services
Purchase Activity outside of the client environment
Purchase Activity within the client environment.

From consumer mobile device 50 To backbone server 10: All Account
Activity

Changes
Purchases
Use

Data is synced in real-time as the elements in Table 15 are changed when internet connectivity is available or the data is exchanged in batch when connectivity becomes available. Alternatively, communication between the client environment proxy server 14 and backbone server 10 will result in transfer of the data sets in Table 15 when connectivity is available between those two elements as previously described.

Having now described the invention in detail as required by the patent statutes, those skilled in the art will recognize modifications and substitutions to the specific embodiments disclosed herein. Such modifications are within the scope and intent of the present invention as defined in the following claims.

What is claimed is:

1. A system for proxy goods and services presentation comprising:
a backbone server having internet and secure link connectivity;
a client environment proxy server connected for internet communication with the backbone server and having network connectivity;
at least one client back end server connected to the backbone server;
at least one client website connected to the backbone server;
at least one merchant gateway connected to the backbone server through a secure link;
a point of sale device connected to the client environment proxy server through a network; and,
a consumer mobile device connected to the client environment proxy server through the network.

2. The system for proxy goods and services presentation as defined in claim 1 wherein the point of sale device further comprises:
a native database incorporated in the point of sale device;
mobile POS software operable with the native database; and,
a payment processing device.

3. The system for proxy goods and services presentation as defined in claim 2 wherein the client environment proxy server communicates to the consumer mobile device goods and services data such as goods and services available and goods and services available at location.

4. The system for proxy goods and services presentation as defined in claim 2 wherein the client environment proxy server communicates to the point of sale device goods and services data such as goods and services available and goods and services available at location.

5. The system for proxy goods and services presentation as defined in claim 3 wherein the client environment proxy server communicates to the consumer mobile device pricing of all goods and services, purchase activity outside of client environment and purchase activity within client environment.

6. The system for proxy goods and services presentation as defined in claim 4 wherein the client environment proxy server communicates to the point of sale device pricing of all goods and services, purchase activity outside of client environment and purchase activity within client environment.

7. The system for proxy goods and services presentation as defined in claim 6 wherein in the point of sale device communicates to the client environment proxy server Consumer Purchases, Consumer Account Changes, Consumer Account Activity, Consumer Loyalty Debits and Credits.

8. The system for proxy goods and services presentation as defined in claim 5 wherein in the consumer mobile device communicates to the client environment proxy server Consumer sales data and inventory data.

9. A method for proxy goods and services presentation comprising:
providing a backbone server having internet and secure link connectivity;
connecting a client environment proxy server for internet communication with the backbone server;
connecting at least one client back end server to the backbone server;
connecting at least one client website to the backbone server;
connecting at least one merchant gateway to the backbone server through a secure link;
connecting a point of sale device to the client environment proxy server through a network; and,
connecting a consumer mobile device to the client environment proxy server through the network.

10. The method for proxy goods and services presentation as defined in claim 9 further comprising communicating from the client environment proxy server to the consumer mobile device goods and services data such as goods and services available and goods and services available at location.

11. The method for proxy goods and services presentation as defined in claim 9 further comprising communicating from the client environment proxy server to the point of sale device goods and services data such as goods and services available and goods and services available at location.

12. The method for proxy goods and services presentation as defined in claim 10 further comprising communicating from the client environment proxy server to the consumer mobile device pricing of all goods and services, purchase activity outside of client environment and purchase activity within client environment.

13. The method for proxy goods and services presentation as defined in claim 11 further comprising communicating from the client environment proxy server to the point of sale device pricing of all goods and services, purchase activity outside of client environment and purchase activity within client environment.

14. The method for proxy goods and services presentation as defined in claim 13 further comprising communicating from the point of sale device to the client environment proxy server Consumer Purchases, Consumer Account Changes, Consumer Account Activity, Consumer Loyalty Debits and Credits.

15. The method for proxy goods and services presentation as defined in claim 12 further comprising communicating from the consumer mobile device to the client environment proxy server Consumer sales data and inventory data.

16. The method for proxy goods and services presentation as defined in claim 14 further comprising communicating from the client environment proxy server to the backbone server transactions and activity data including consumer purchases, consumer account changes, consumer loyalty debits and credits, client inventory levels, vendor inventory levels, client sales activity and vendor sales activity.

17. The method for proxy goods and services presentation as defined in claim 15 further comprising communicating from the client environment proxy server to the backbone server transactions and activity data including consumer purchases, consumer account changes, consumer loyalty debits and credits, client inventory levels, vendor inventory levels, client sales activity and vendor sales activity.

18. The method for proxy goods and services presentation as defined in claim 9 further comprising:
communicating from the at least one client back end server to the backbone server data selected from the set of available goods and services, client environment data, consumer information, loyalty information, reservation data; and
communicating from the backbone server to the at least one client back end server data selected from the set of inventory levels, consumer sales data, loyalty updates and consumer history.

19. The method for proxy goods and services presentation as defined in claim 9 further comprising:
communicating from the client website to the backbone server data selected from the set of available goods and services, pricing information, inventory levels, location based sales availability data; and,
communicating from the backbone server to the client website data selected from the set of sales data and current inventory levels.

20. The method for proxy goods and services presentation as defined in claim 9 further comprising:
communicating from the backbone server to the merchant gateway data selected form the set of Payment Account Information and pricing Information; and,
communicating from the merchant gateway to the backbone server data selected from the set of approval receipts and denial receipts.
